(19) United States
(12) Patent Application Publication
(10) Pub. No.: US 2014/0115697 A1
(43) Pub. Date: Apr. 24, 2014

(54) Data Management Method and Apparatus

(71) Applicant: Huawei Technologies Co., Ltd., Shenzhen (CN)

(72) Inventors: Yonghong Wang, Shanghai (CN); Xiuyi Li, Shenzhen (CN); Ming Zhang, Shanghai (CN); Weimin Zhou, Shanghai (CN)

(73) Assignee: Huawei Technologies Co., Ltd., Shenzhen (CN)

(21) Appl. No.: 14/145,455

(22) Filed: Dec. 31, 2013

Related U.S. Application Data
(63) Continuation of application No. PCT/CN2011/077971, filed on Aug. 3, 2011.

(51) Int. Cl. G06F 21/33

(52) U.S. Cl. CPC G06F 21/33
USPC 726/19

(57) ABSTRACT

The present invention relates to communications technologies and discloses a data management method and apparatus, so as to solve a problem of customer churn for an operator caused by existing data management. The technical solutions provided in the embodiments of the present invention include: acquiring an operator identification code of a terminal and a preset terminal identification code, where the terminal identification code is not rewritable and uniquely corresponds to the terminal; performing a hash operation on first data by using a preset hash algorithm to obtain a first hash value; detecting whether a signature is consistent with the first hash value to obtain a detection result; and determining whether the terminal has permission to be used according to the detection result. The embodiments of the present invention can be applied to a mobile terminal such as a mobile phone.

### CROSS-REFERENCE TO RELATED APPLICATIONS

This application is a continuation of International Application No. PCT/CN2011/077971, filed on Aug. 3, 2011, which is hereby incorporated by reference in its entirety.

### TECHNICAL FIELD

The present invention relates to communications technologies, and in particular to a data management method and apparatus.

### BACKGROUND

In the prior art, a secure boot technology can be used by operators to implement data management for a terminal. A specific process in which a secure boot technology is used by an operator to implement data management for a terminal includes: generating an initial operator identification code and a corresponding program image in a flash memory of the terminal according to a network locking requirement of the terminal; generating a signature in the flash memory according to the initial operator identification code and the program image, where the signature is rewritable; when the terminal starts, performing a hash operation on the initial operator identification code and the program image in the flash memory by using a hash algorithm preset by the terminal to obtain a hash value; detecting whether the signature is consistent with the hash value, where if yes, it indicates that the initial operator identification code in the flash memory and a program are not illegally changed; and determining whether the terminal has permission to be used according to a detection result.

When the foregoing secure boot technology is used by an operator to implement data management for a terminal, the inventor finds that the prior art has at least the following problem: An illegal user can replace a program image of a current terminal with a program image of a terminal with the same hardware configuration, where the terminal is customized by another operator, and it is difficult to detect such a replacement, which results in customer churn of the operator, thereby causing loss to the operator.

### SUMMARY

Embodiments of the present invention provide a data management method and apparatus, which can detect that an illegal user replaces a program image of a current terminal with a program image of a terminal with the same hardware configuration, where the terminal is customized by another operator.

According to one aspect, a data management method is provided and includes: acquiring an operator identification code of the terminal and a preset terminal identification code, where the terminal identification code is not rewritable and uniquely corresponds to the terminal; performing a hash operation on first data by using a preset hash algorithm to obtain a first hash value, where the first data includes the terminal identification code and the operator identification code; detecting whether a signature is consistent with the first hash value to obtain a detection result, where the signature is generated in advance according to the terminal identification code and an initial operator identification code, and the initial operator identification code is generated in advance by the terminal; and determining whether the terminal has permission to be used according to the detection result.

According to another aspect, a data management apparatus is provided and includes: a data acquiring module configured to acquire an operator identification code of the terminal and a preset terminal identification code, where the terminal identification code is not rewritable and uniquely corresponds to the terminal; a hash value acquiring module configured to perform a hash operation on first data by using a preset hash algorithm to obtain a first hash value, where the first data includes the terminal identification code and the operator identification code that are acquired by the data acquiring module; a first detecting module configured to detect whether a signature is consistent with the first hash value acquired by the hash value acquiring module to obtain a detection result, where the signature is generated in advance according to the terminal identification code and an initial operator identification code, and the initial operator identification code is generated in advance by the terminal; and a permission determining module configured to determine whether the terminal has permission to be used according to the detection result obtained by the first detecting module.

According to the data management method and apparatus provided in the embodiments of the present invention, a hash operation is performed on a terminal identification code and an operator identification code to obtain a first hash value; and whether the first hash value is consistent with a signature generated in advance is detected; and then using permission of a terminal is determined according to a detection result. In this way, data management for the terminal is implemented. Because the terminal identification code is not rewritable, it is difficult for an illegal user to replace a signature of a current terminal with a signature of a terminal that is customized by another operator, and a replacement of a program image of the current terminal with the program image can be detected. In the embodiments of the present invention, a problem in the prior art that an illegal user can replace a program image of a current terminal with the program image of a terminal with the same hardware configuration, where the terminal is customized by another operator, which results in customer churn of the operator, thereby causing loss to the operator is solved.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show only some embodiments of the present invention, and persons of ordinary skill in the art may still derive other drawings from these accompanying drawings without creative efforts.

FIG. 1 is a flowchart of a data management method according to a first embodiment of the present invention;

FIG. 2 is a flowchart of a data management method according to a second embodiment of the present invention;

FIG. 3 is a flowchart of a data management method according to a third embodiment of the present invention;

FIG. 4 is a first schematic structural diagram of a data management apparatus according to a fourth embodiment of the present invention;

FIG. 5 is a second schematic structural diagram of a data management apparatus according to the fourth embodiment of the present invention; and

FIG. 6 is a third schematic structural diagram of a data management apparatus according to the fourth embodiment of the present invention.

### DESCRIPTION OF EMBODIMENTS

The following clearly and completely describes the technical solutions in the embodiments of the present invention with reference to the accompanying drawings in the embodiments of the present invention. Apparently, the embodiments to be described are only a part rather than all of the embodiments of the present invention. All other embodiments obtained by persons of ordinary skill in the art based on the embodiments of the present invention without creative efforts shall fall within the protection scope of the present invention.

To solve a problem of customer churn for an operator caused by existing data management, embodiments of the present invention provide a data management method and apparatus.

Step 101: Acquire an operator identification code of a terminal and a preset terminal identification code.

In this embodiment, the operator identification code in step 101 is used for association with an operator and includes a public land mobile network (PLMN) identification code; and it is rewritable and the operator identification code may be used to establish association with an operator. The operator identification code in step 101 may be related to an operator network; and for a different operator network, the operator identification code is different. The operator identification code may be a PLMN identification code, and may also be another identification code, which is not described in detail one by one herein.

In this embodiment, the preset terminal identification code in step 101 is not rewritable and uniquely corresponds to the terminal. The terminal identification code is used for hardware association with a terminal, and may be set inside a chip of a terminal when the terminal is produced.

In this embodiment, through step 101, the operator identification code may be acquired from a data card of the terminal, and the operator identification code may also be acquired from a flash memory of the terminal, which is not described in detail one by one herein. The data card of the terminal may be a subscriber identity module (SIM), may also be a universal subscriber identity module (USIM), and may also be another type of subscriber identity card, which is not limited herein.

Step 102: Perform a hash operation on first data by using a preset hash algorithm to obtain a first hash value.

In this embodiment, the first data in step 102 may include the terminal identification code and the operator identification code and may further include another content such as secure data, which is not limited herein. The secure data is data for forbidding an illegal user to tamper and is used to impose a functional limitation on the terminal.

In this embodiment, a process for performing the hash operation on the first data by using the preset hash algorithm in step 102 may be implemented by setting a corresponding code of the hash algorithm in the terminal, and may also be implemented in another manner, which is not described in detail one by one herein.

Step 103: Detect whether a signature is consistent with the first hash value to obtain a detection result.

In this embodiment, the signature in step 103 is generated in advance according to the terminal identification code and an initial operator identification code, and the initial operator identification code is generated in advance by the terminal. When a form of the signature is a hash value, whether the signature is consistent with the first hash value can be directly detected through step 103; and when the form of the signature is ciphertext obtained by encrypting a hash value, first the signature needs to be decrypted, and then whether a decryption result is consistent with the first hash value is detected through step 103.

Step 104: Determine whether the terminal has permission to be used according to the detection result.

In this embodiment, when the detection result obtained through step 103 indicates that the signature is consistent with the first hash value, the terminal has using permission; and according to the detection result, the terminal can be normally used. When the detection result obtained through step 103 indicates that the signature is inconsistent with the first hash value, the terminal does not have using permission; and according to the detection result, the terminal runs an error handling program and cannot be normally used.

According to the data management method provided in this embodiment of the present invention, a hash operation is performed on a terminal identification code and an operator identification code to obtain a first hash value; and whether the first hash value is consistent with a signature generated in advance is detected; and then using permission of a terminal is determined according to a detection result. In this way, data management for the terminal is implemented. Because the terminal identification code is not rewritable, it is difficult for an illegal user to replace a signature of a current terminal with a signature of a terminal that is customized by another operator, and a replacement of a program image of the current terminal with the program image can be detected. In this embodiment of the present invention, a problem in the prior art that an illegal user can replace a program image of a current terminal with the program image of a terminal with the same hardware configuration, where the terminal is customized by another operator, which results in customer churn of the operator, thereby causing loss to the operator is solved.

As shown in FIG. 2, a data management method provided in a second embodiment of the present invention includes:

Step 201: Generate an initial operator identification code in a flash memory of a terminal according to a network locking requirement of the terminal.

In this embodiment, when producing a terminal, a terminal manufacturer may generate an initial operator identification code in a flash memory of the terminal through step 201. After the initial operator identification code is generated in the flash memory of the terminal through step 201, the terminal manufacturer or a user may modify the initial operator identification code as required, so as to obtain a modified operator identification code.

Step 202: Generate a signature according to second data.

In this embodiment, the signature in step 202 is rewritable, and the second data may include an initial operator identification code and a terminal identification code and may further include another content such as secure data, which is not limited herein. A process for generating a signature through step 202 may include performing a hash operation on second data by using a preset hash algorithm, where an obtained second hash value is the signature; and to increase reliability of the signature, it may also include performing a hash operation on second data by using a preset hash algorithm to obtain a second hash value, and then encrypt the second hash value, where obtained ciphertext is the signature.

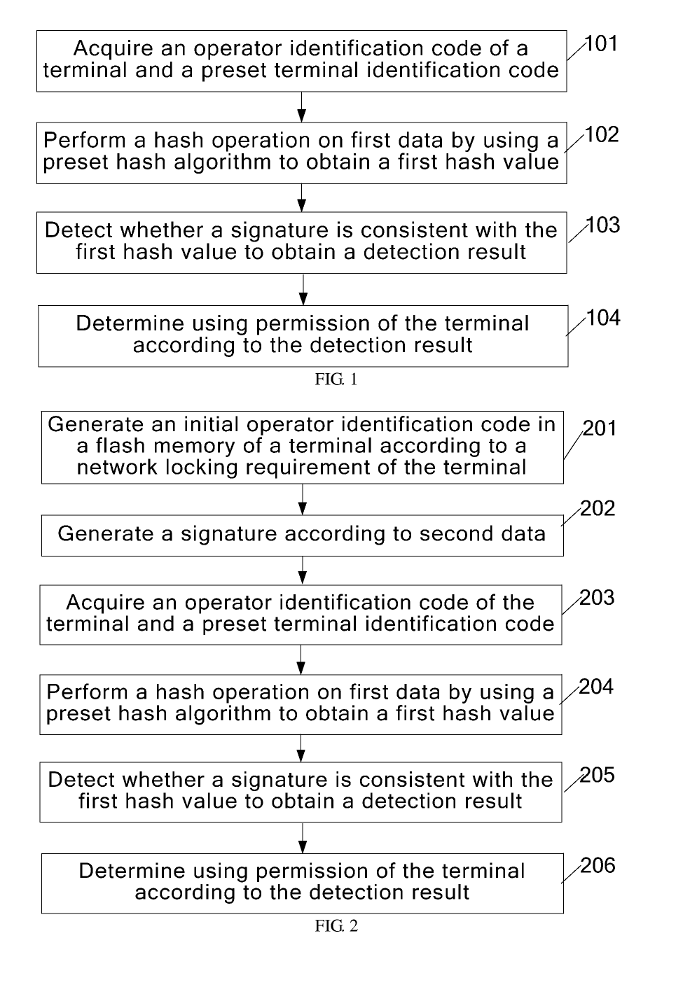

Step 203 to step 204: Acquire an operator identification code of the terminal and a preset terminal identification code, and perform a hash operation on first data by using a preset hash algorithm. For a detailed process, reference may be made to step 101 to step 102 shown in FIG. 1, which is not described in detail one by one herein.

Step 205: Detect whether the signature is consistent with a first hash value to obtain a detection result.

In this embodiment, if the signature in step 205 is generated according to the initial operator identification code and the terminal identification code through step 202, correspondingly, the first hash value is generated according to the operator identification code and the terminal identification code through step 204; and if the signature in step 205 is generated according to the initial operator identification code, the terminal identification code, and the secure data through step 202, correspondingly, the first hash value is generated according to the operator identification code, the terminal identification code, and the secure data through step 204.

In this embodiment, if the signature in step 205 is the second hash value that is obtained by performing the hash operation on the second data by using the preset hash algorithm, a process for detecting whether the signature is consistent with a first hash value through step 205 is as follows: Detect whether the second hash value is consistent with the first hash value. If the signature in step 205 is the ciphertext obtained by encrypting the second hash value that is obtained by performing the hash operation on the second data by using the preset hash algorithm, a process for detecting whether the signature is consistent with the first hash value is as follows: Decrypt the signature to obtain a third hash value, and then detect whether the third hash value is consistent with the first hash value to obtain a detection result.

In this embodiment, when a public key corresponding to a private key used for encrypting the second hash value is a public key in a root certificate, the signature can be directly decrypted by using the public key in the root certificate. When the public key corresponding to the private key used for encrypting the second hash value is a public key in a certificate in the flash memory of the terminal, in order to increase security of network communications, the public key in the certificate in the flash memory may be encrypted in advance to obtain an encrypted public key; and in this case, a process for decrypting the signature may include: The terminal first decrypts the encrypted public key by using the public key in the root certificate to obtain the public key in the certificate in the flash memory, and then the terminal decrypts the signature by using the public key in the certificate in the flash memory.

Step 206: Determine whether the terminal has permission to be used according to the detection result. A detailed process is similar to step 104 shown in FIG. 1, which is not described in detail one by one herein.

According to the data management method provided in this embodiment of the present invention, a hash operation is performed on a terminal identification code and an initial operator identification code to obtain a first hash value; and whether the first hash value is consistent with a signature generated in advance is detected; and then using permission of a terminal is determined according to a detection result. In this way, data management for the terminal is implemented. Because the terminal identification code is not rewritable, it is difficult for an illegal user to replace a signature of a current terminal with a signature of a terminal that is customized by another operator, and a replacement of a program image of the current terminal with the program image can be detected. In this embodiment of the present invention, a problem in the prior art that an illegal user can replace a program image of a current terminal with the program image of a terminal with the same hardware configuration, where the terminal is customized by another operator, which results in customer churn of the operator, thereby causing loss to the operator is solved.

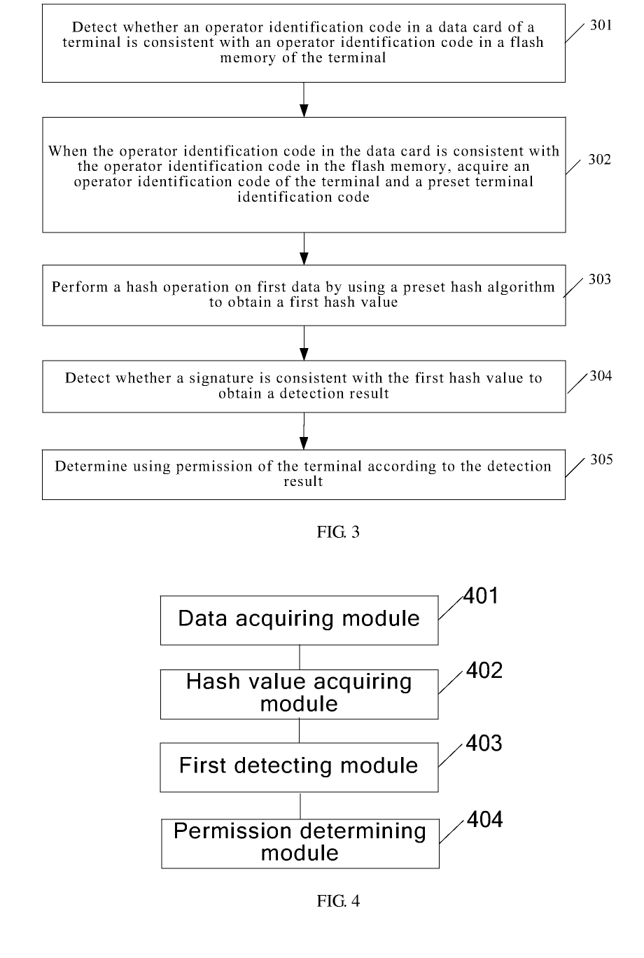

As shown in FIG. 3, a data management method provided in a third embodiment of the present invention includes:

Step 301: Detect whether an operator identification code in a data card of a terminal is consistent with an operator identification code in a flash memory of the terminal.

In this embodiment, whether the operator identification code in the data card of the terminal is consistent with the operator identification code in the flash memory of the terminal may be first detected through step 301 in order to prevent a user from modifying the operator identification code in the data card or the operator identification code in the flash memory of the terminal. When it is detected through step 301 that the operator identification code in the data card of the terminal is consistent with the operator identification code in the flash memory of the terminal, the operator identification code and a terminal identification code may be acquired through step 302; optionally, when it is detected through step 301 that the operator identification code in the data card of the terminal is inconsistent with the operator identification code in the flash memory of the terminal, the terminal may run an error handling program and cannot be normally used.

Step 302: When the operator identification code in the data card is consistent with the operator identification code in the flash memory, acquire an operator identification code of the terminal and a preset terminal identification code. A detailed process is similar to step 101 shown in FIG. 1, which is not described in detail one by one herein.

Step 303 to step 305: Perform a hash operation on first data to obtain a first hash value, then detect whether a signature is consistent with the first hash value and determine whether the terminal has permission to be used according to a detection result. A detailed process is similar to step 102 to step 104 shown in FIG. 1, which is not described in detail one by one herein.

According to the data management method provided in this embodiment of the present invention, a hash operation is performed on a terminal identification code and an operator identification code to obtain a first hash value; and whether the first hash value is consistent with a signature generated in advance is detected; and then using permission of a terminal is determined according to a detection result. In this way, data management for the terminal is implemented. Because the terminal identification code is not rewritable, it is difficult for an illegal user to replace a signature of a current terminal with a signature of a terminal that is customized by another operator, and a replacement of a program image of the current terminal with the program image can be detected. In this embodiment of the present invention, a problem in the prior art that an illegal user can replace a program image of a current terminal with the program image of a terminal with the same hardware configuration, where the terminal is customized by another operator, which results in customer churn of the operator, thereby causing loss to the operator is solved.

As shown in FIG. 4, a data management apparatus provided in a fourth embodiment of the present invention includes:

A data acquiring module 401 is configured to acquire an operator identification code of a terminal and a preset terminal identification code, where the terminal identification code is not rewritable and uniquely corresponds to the terminal.

In this embodiment, the operator identification code in the data acquiring module 401 is used for association with an operator and includes a PLMN identification code; and it is rewritable and may be used to establish association with an operator. The operator identification code in the data acquiring module 401 may be related to an operator network; and for a different operator network, the operator identification code is different. The operator identification code may be a PLMN identification code, and may also be another identification code, which is not described in detail one by one herein.

In this embodiment, the preset terminal identification code in the data acquiring module 401 is not rewritable and uniquely corresponds to the terminal. The terminal identification code is used for hardware association with a terminal, and may be set inside a chip of a terminal when the terminal is produced.

In this embodiment, through the data acquiring module 401, the operator identification code may be acquired from a data card of the terminal, and the operator identification code may also be acquired from a flash memory of the terminal, which is not described in detail one by one herein. The data card of the terminal may be a SIM, may also be a USIM, and may also be another type of subscriber identity card, which is not limited herein.

A hash value acquiring module 402 is configured to perform a hash operation on first data by using a preset hash algorithm to obtain a first hash value, where the first data includes the terminal identification code and the operator identification code that are acquired by the data acquiring module.

In this embodiment, the first data in the hash value acquiring module 402 may include the terminal identification code and the operator identification code and may further include another content such as secure data, which is not limited herein. The secure data is data for forbidding an illegal user to tamper and is used to impose a functional limitation on the terminal.

In this embodiment, a process for performing the hash operation on the first data by using the preset hash algorithm in the hash value acquiring module 402 may be implemented by setting a corresponding code of the hash algorithm in the terminal, and may also be implemented in another manner, which is not described in detail one by one herein.

A first detecting module 403 is configured to detect whether a signature is consistent with the first hash value acquired by the hash value acquiring module to obtain a detection result, where the signature is generated in advance according to the terminal identification code and an initial operator identification code, and the initial operator identification code is generated in advance by the terminal.

In this embodiment, the signature in the first detecting module 403 is generated in advance according to the terminal identification code and an initial operator identification code, and the initial operator identification code is generated in advance by the terminal. When a form of the signature is a hash value, whether the signature is consistent with the first hash value can be directly detected through the first detecting module 403; and when the form of the signature is ciphertext obtained by encrypting a hash value, first the signature needs to be decrypted, and then whether a decryption result is consistent with the first hash value is detected through the first detecting module 403.

A permission determining module 404 is configured to determine whether the terminal has permission to be used according to the detection result obtained by the first detecting module.

In this embodiment, the permission determining module 404 may include a first determining submodule and a second determining submodule. The first determining submodule is configured to determine that the terminal has using permission when the detection result obtained by the first detecting module indicates that the signature is consistent with the first hash value, that is, to determine, according to the detection result, that the terminal can be normally used. The second determining submodule is configured to determine that the terminal does not have using permission when the detection result obtained by the first detecting module indicates that the signature is inconsistent with the first hash value, that is, to determine, according to the detection result, that the terminal runs an error handling program and cannot be normally used.

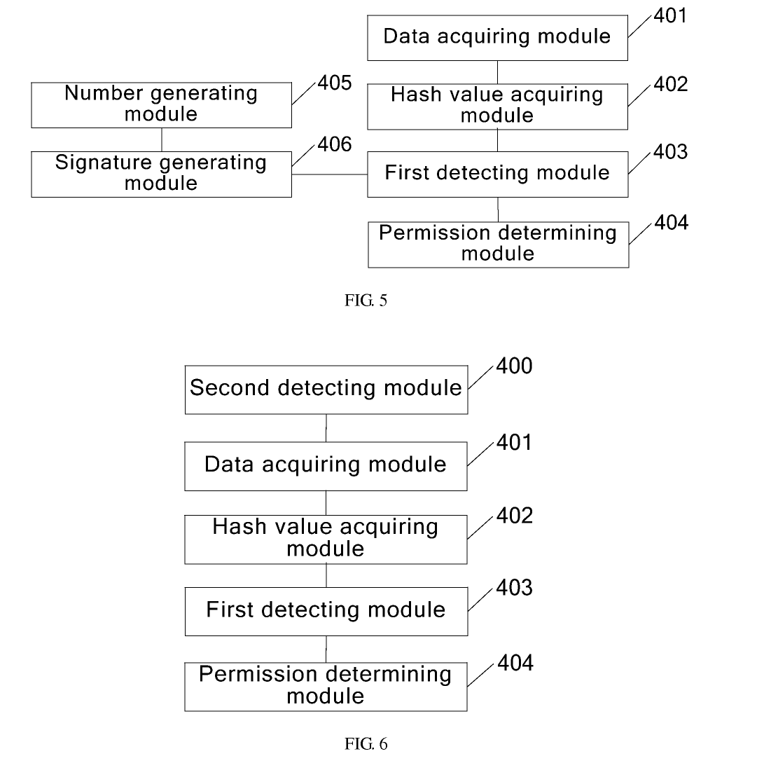

Further, as shown in FIG. 5, the data management apparatus according to this embodiment may further include:

A number generating module 405 is configured to generate an initial operator identification code in a flash memory of a terminal according to a network locking requirement of the terminal.

In this embodiment, when producing a terminal, a terminal manufacturer may generate an initial operator identification code in a flash memory of the terminal through the number generating module 405. After the initial operator identification code is generated in the flash memory of the terminal through the number generating module 405, the terminal manufacturer or a user may modify the initial operator identification code as required, so as to obtain a modified operator identification code.

A signature generating module 406 is configured to generate a signature according to second data, where the signature is rewritable, and the second data includes the initial operator identification code generated by the number generating module and a terminal identification code.

In this embodiment, the signature in the signature generating module 406 is rewritable, and the second data may include the initial operator identification code and the terminal identification code and may further include another content such as secure data, which is not limited herein. A process for generating a signature through the signature generating module 406 may include performing a hash operation on second data by using a preset hash algorithm, where an obtained second hash value is the signature; and to increase reliability of the signature, it may also include: performing a hash operation on second data by using a preset hash algorithm to obtain a second hash value, and then encrypt the second hash value, where obtained ciphertext is the signature.

In this embodiment, if the signature in the first detecting module 403 is generated according to the initial operator identification code and the terminal identification code through step 202, correspondingly, the first hash value is generated according to the operator identification code and the terminal identification code through the hash value acquiring module 402; and if the signature in the first detecting module 403 is generated according to the initial operator identification code, the terminal identification code, and the secure data through the signature generating module 406, correspondingly, the first hash value is generated according to the operator identification code, the terminal identification code, and the secure data through the hash value acquiring module 402.

In this embodiment, if the signature in the first detecting module 403 is the second hash value that is obtained by performing the hash operation on the second data by using the preset hash algorithm, a process for detecting whether the signature is consistent with the first hash value through the first detecting module 403 is as follows: Detect whether the second hash value is consistent with the first hash value. If the signature in the first detecting module 403 is the ciphertext obtained by encrypting the second hash value that is obtained by performing the hash operation on the second data by using the preset hash algorithm, a process for detecting whether the signature is consistent with the first hash value through the first detecting module 403 is as follows: Decrypt the signature to obtain a third hash value, and then detect whether the third hash value is consistent with the first hash value to obtain a detection result. In this case, the first detecting module 403 includes: a decrypting submodule configured to decrypt the signature to obtain the third hash value; and a detecting submodule configured to detect whether the third hash value is consistent with the first hash value to obtain the detection result.

In this embodiment, when a public key corresponding to a private key used for encrypting the second hash value is a public key in a root certificate, the signature can be directly decrypted by using the public key in the root certificate. When the public key corresponding to the private key used for encrypting the second hash value is a public key in a certificate in the flash memory of the terminal, in order to increase security of the network communication, the public key in the certificate in the flash memory can be encrypted in advance to obtain an encrypted public key; and in this case, a process for decrypting the signature may include: The terminal first decrypts the encrypted public key by using the public key in the root certificate to obtain the public key in the certificate in the flash memory, and then the terminal decrypts the signature by using the public key in the certificate in the flash memory.

Further, as shown in FIG. 6, the data management apparatus according to this embodiment may further include:

A second detecting module 400 is configured to detect whether an operator identification code in a data card of a terminal is consistent with an operator identification code in a flash memory of the terminal.

In this embodiment, whether the operator identification code in the data card of the terminal is consistent with the operator identification code in the flash memory of the terminal may be first detected through the second detecting module 400 in order to prevent a user from modifying the operator identification code in the data card or the operator identification code in the flash memory of the terminal. When it is detected through the second detecting module 400 that the operator identification code in the data card of the terminal is consistent with the operator identification code in the flash memory of the terminal, the operator identification code and a terminal identification code may be acquired through the data acquiring module 401; optionally, when it is detected through the second detecting module 400 that the operator identification code in the data card of the terminal is inconsistent with the operator identification code in the flash memory of the terminal, the terminal may run an error handling program and cannot be normally used.

In this case, the data acquiring module 401 is specifically configured to acquire the operator identification code of the terminal and a preset terminal identification code when the operator identification code in the data card is consistent with the operator identification code in the flash memory.

According to the data management apparatus provided in this embodiment of the present invention, a hash operation is performed on a terminal identification code and an operator identification code to obtain a first hash value; and whether the first hash value is consistent with a signature generated in advance is detected; and then using permission of a terminal is determined according to a detection result. In this way, data management for the terminal is implemented. Because the terminal identification code is not rewritable, it is difficult for an illegal user to replace a signature of a current terminal with of a terminal that is customized by another operator, and a replacement of a program image of the current terminal with the program image can be detected. In this embodiment of the present invention, a problem in the prior art that an illegal user can replace a program image of a current terminal with the program image of a terminal with the same hardware configuration, where the terminal is customized by another operator, which results in customer churn of the operator, thereby causing loss to the operator is solved.

The data management method and apparatus provided in the embodiments of the present invention can be applied to a mobile terminal such as a mobile phone.

The steps of the method or algorithm described in the embodiments disclosed in this specification may be directly implemented by hardware, a software module executed by a processor, or a combination of the two. The software module may be placed in a random access memory (RAM), a memory, a read-only memory (ROM), an electrically programmable ROM, an electrically erasable programmable ROM, a register, a hard disk, a removable disk, a compact disc (CD)-ROM, or any other storage media known in the technical field.

The foregoing descriptions are only specific embodiments of the present invention, but are not intended to limit the protection scope of the present invention. Any variation or replacement readily figured out by persons skilled in the art within the technical scope disclosed in the present invention shall all fall within the protection scope of the present invention. Therefore, the protection scope of the present invention shall be subject to the protection scope of the claims.

What is claimed is:

1. A data management method, comprising:
acquiring an operator identification code of a terminal and a preset terminal identification code, wherein the terminal identification code is not rewritable and uniquely corresponds to the terminal;
performing a hash operation on first data by using a preset hash algorithm to obtain a first hash value, wherein the first data comprises the terminal identification code and the operator identification code;
detecting whether a signature is consistent with the first hash value, thereby obtaining a detection result, wherein the signature is generated in advance according to the terminal identification code and an initial operator identification code, and wherein the initial operator identification code is generated in advance by the terminal; and
determining whether the terminal has permission to be used according to the detected result.

2. The data management method according to claim 1, wherein before acquiring the operator identification code of the terminal and the preset terminal identification code, the method further comprises:
generating the initial operator identification code in a flash memory of the terminal according to a network locking requirement of the terminal; and
generating the signature according to second data, wherein the signature is rewritable, and wherein the second data comprises the initial operator identification code and the terminal identification code.

3. The data management method according to claim 2, wherein the signature is a second hash value obtained by performing a hash operation on the second data by using the preset hash algorithm.

4. The data management method according to claim 2, wherein the signature is ciphertext obtained by encrypting a second hash value that is obtained by performing a hash operation on the second data by using the preset hash algorithm.

5. The data management method according to claim 1, wherein before acquiring the operator identification code of the terminal and the preset terminal identification code, the method further comprises detecting whether an operator identification code in a data card of the terminal is consistent with an operator identification code in a flash memory of the terminal, and wherein acquiring the operator identification code of the terminal and the preset terminal identification code specifically comprises obtaining the operator identification code of the terminal and the preset terminal identification code when the operator identification code in the data card is consistent with the operator identification code in the flash memory.

6. The data management method according to claim 1, wherein detecting whether the signature is consistent with the first hash value comprises:
decrypting the signature to obtain a third hash value; and
detecting whether the third hash value is consistent with the first hash value.

7. The data management method according to claim 1, wherein the terminal identification code is used for hardware association with the terminal, and wherein the operator identification code is used for association with an operator and comprises a public land mobile network (PLMN) identification code.

8. The data management method according to claim 1, wherein determining whether the terminal has permission to be used according to the detection result comprises:
determining that the terminal has the using permission when the detection result indicates that the signature is consistent with the first hash value; and
determining that the terminal does not have the using permission when the detection result indicates that the signature is inconsistent with the first hash value.

9. The data management method according to claim 1, wherein the first data further comprises secure data, wherein the second data further comprises the secure data, and wherein the secure data is data for forbidding an illegal user to tamper with the terminal and is used to impose a functional limitation on the terminal.

10. A data management apparatus, comprising:
a data acquiring module configured to acquire an operator identification code of a terminal and a preset terminal identification code, wherein the terminal identification code is not rewritable and uniquely corresponds to the terminal;
a hash value acquiring module configured to perform a hash operation on first data by using a preset hash algorithm to obtain a first hash value, wherein the first data comprises the terminal identification code and the operator identification code that are acquired by the data acquiring module;
a first detecting module configured to detect whether a signature is consistent with the first hash value acquired by the hash value acquiring module, thereby obtaining a detection result, wherein the signature is generated in advance according to the terminal identification code and an initial operator identification code, and wherein the initial operator identification code is generated in advance by the terminal; and
a permission determining module configured to determine whether the terminal has permission to be used according to the detection result obtained by the first detecting module.

11. The data management apparatus according to claim 10, further comprising:
a number generating module configured to generate the initial operator identification code in a flash memory of the terminal according to a network locking requirement of the terminal; and
a signature generating module configured to generate the signature according to second data, wherein the signature is rewritable, and wherein the second data comprises the initial operator identification code generated by the number generating module and the terminal identification code.

12. The data management apparatus according to claim 10, further comprising a second detecting module configured to detect whether an operator identification code in a data card of the terminal is consistent with an operator identification code in a flash memory of the terminal, wherein the data acquiring module is specifically configured to obtain the operator identification code of the terminal and the preset terminal identification code when the operator identification code in the data card is consistent with the operator identification code in the flash memory.

13. The data management apparatus according to claim 10, wherein the first detecting module comprises:
a decrypting submodule configured to decrypt the signature to obtain a third hash value; and
a detecting submodule configured to detect whether the third hash value is consistent with the first hash value to obtain the detection result.

14. The data management apparatus according to claim 10, wherein the terminal identification code is used for hardware association with the terminal; and wherein the operator identification code is used for association with an operator and comprises a public land mobile network (PLMN) identification code.

15. The data management apparatus according to claim 10, wherein the permission determining module comprises:
a first determining submodule configured to determine that the terminal has using permission when the detection result obtained by the first detecting module indicates that the signature is consistent with the first hash value; and
a second determining submodule configured to determine that the terminal does not have using permission when the detection result obtained by the first detecting module indicates that the signature is inconsistent with the first hash value.

16. The data management apparatus according to claim 10, wherein the first data further comprises secure data, wherein the second data further comprises secure data, and wherein the secure data is data for forbidding an illegal user to tamper and is used to impose a functional limitation on the terminal.

17. An apparatus comprising:
a processor configured to:
acquire an operator identification code of a terminal and a preset terminal identification code, wherein the terminal identification code is not rewritable and uniquely corresponds to the terminal;
perform a hash operation on first data by using a preset hash algorithm to obtain a first hash value, wherein the first data comprises the terminal identification code and the operator identification code;
detect whether a signature is consistent with the first hash value, thereby obtaining a detection result, wherein the signature is generated in advance according to the terminal identification code and an initial operator identification code, and wherein the initial operator identification code is generated in advance by the terminal; and
determine whether a user has permission to use the terminal according to the detected result.

18. The apparatus according to claim 17, wherein before acquiring the operator identification code of the terminal and the preset terminal identification code, the processor is further configured to:
generate the initial operator identification code in a flash memory of the terminal according to a network locking requirement of the terminal; and
generate the signature according to second data, wherein the signature is rewritable, and wherein the second data comprises the initial operator identification code and the terminal identification code.

19. The apparatus according to claim 18, wherein the signature is a second hash value obtained by performing a hash operation on the second data by using the preset hash algorithm.

20. The apparatus according to claim 18, wherein the signature is ciphertext obtained by encrypting a second hash value that is obtained by performing a hash operation on the second data by using the preset hash algorithm.
